(19) United States
(12) Patent Application Publication
(10) Pub. No.: US 2009/0252415 A1
(43) Pub. Date: Oct. 8, 2009

(54) Method for retrieving text blocks in documents

(75) Inventor: Katja Worm, Berlin (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Aktiengesellschaft, Muenchen (DE)

(21) Appl. No.: 11/991,058

(22) PCT Filed: Aug. 11, 2006
(86) PCT No.: PCT/EP2006/007939

§ 371 Date: Feb. 26, 2008

(30) Foreign Application Priority Data
Aug. 26, 2005 (DE) 10 2005 040 687.4

(51) Int. Cl. G06K 9/34; G06K 9/62

(52) U.S. Cl. 382/176; 382/282; 382/224

(57) ABSTRACT

To classify text blocks in printed material which is part of bulk postal items structure-related characteristics of one of the text blocks of a postal item are extracted, wherein the characteristics are characterized by graphical properties of the overall text block. The extracted structure-related characteristics are assigned to a characteristic data record of the postal item, and a characteristic data record of a reference text block is compared to the characteristic data record of the postal item.

The invention relates to a method for retrieving text blocks in documents as claimed in the preamble of claim 1.

In printed material such as digitized documents or postal items, which can contain texts, pictures, symbols etc. it is frequently important for specific text blocks or text passages to be found again in the same printed material or other printed material, without the content of these text blocks having to be read or interpreted, because the interpretation (e.g. by an OCR system) can be too time-consuming or error-prone. Obvious applications for this are searching image databases, document management or also evaluation of forms. To this end a characteristic data record of a sample text block is first created and placed or stored in a database. If necessary the same printed material or other printed material is searched to find candidates for the text block to be identified. A characteristic data record is created from the candidates found using the same process and this characteristic data record is compared with the characteristic data records stored in the database.

Generally a plurality of printed material to be searched and/or the complexity of these printed material results in a large search area, especially for sorting postal programs, for the retrieval of such text blocks.

Accordingly characteristics and identification methods must be found which allow a separation of the characteristic data records in the search area. Different text block-descriptive characteristics are used for this purpose.

The challenge lies in the identification of text blocks in very complex printed material or in a very large amount of printed material, if this printed material as a whole has a plurality of text blocks which exhibit a high degree of similarity to the text block sought.

For the selection of suitable characteristics for example the types of postal items to be sorted are of particular importance. A distinction is made between normal items and bulk items. The first type is easy to distinguish with the aid of known methods, since the items differ widely from one another, in their coloration for example. Bulk items of one type however typically have the same coloration. As a rule they have the same elements such as symbols, logos and frankings and differ only in the area of the recipient address. This makes it necessary to execute expensive word recognition for example in order to use address characteristics.

The underlying object of the invention is to specify a simple method for retrieving text blocks in complex printed material, without the text blocks having to be interpreted (e.g. by an OCR system) in respect of their content.

In particular the method is intended to be optimally suited to sorting bulk items to be sent by post.

In accordance with the invention the object is achieved by the features of claim 1.

Using as its starting point a method for retrieving text blocks in documents, preferably for postal items to be sorted, such as bulk postal items, with the aid of characteristic data records of reference text blocks, these text blocks are to be able to be found again or identified in any type of document. In such cases structure-related and text interpretation-free characteristics of the text block are extracted and compared with characteristics of a characteristic data record of a reference text bock, so that where possible there is a simple detection of similar characteristics between a number of text blocks.

In general a text block offers great potential for description by suitable characteristics and thereby for creation of an associated characteristic data record which characterizes it uniquely and differs from other text blocks. It is of particular importance that no content interpretation of the text block and thus no comparison based on the textual context is to be carried out.

In many applications high demands are imposed on the pictorial identification of text blocks. The inventive method thus represents the following advantages:
A high level of robustness because of a pure detection of structurally as well as graphically but not textually interpreted text blocks,
A high identification rate which can be linked to extremely low detection error rates,
A simple rejection of text blocks or of explicit postal items,
A real time capability, i.e. the identification result must be present within a defined time of a few milliseconds, and
A use of characteristics which do not exceed a specific storage capacity.

Advantageous embodiments of the invention are set down in the subclaims.

In a first classification of the text blocks one or if necessary a number of coarse structure-related characteristics of a text block are extracted which relate to the graphical characteristics of the overall text block. These characteristics are significantly easier and faster to recognize than in an interpretation of texts. Typical characteristics involved are a size of the text block, a position of the text block within the printed material, a level of occupancy of the text block, a number of lines in the text block, a size of spaces between lines in the text block and/or a type height of lines in the text block.

In addition to the first classification, in a second classification of the text blocks, one or more fine structure-related characteristics of the text block can be extracted which now relate to graphical characteristics of individual lines in the text block. In such cases however individual text elements such as words are not interpreted. The characteristics used here can be selected from the following: Number of coherent regions within a line, frequency of coherent regions, color value transitions in a line and where necessary its matrix form for a number of lines and/or line profiles.

To assign these characteristics characteristic vectors are used as characteristic data records which are called up for sorting/comparison of for example two text blocks in the identification process.

In particular for example characteristics of a line profile with distances of an area of text from an upper and lower edge of the line are entered in a characteristic vector by means of discrete sampling values along a line for example.

In general the structure-related characteristics of a text block of printed material are arranged in a characteristic data record such that a comparison between two characteristics of the same category can still be undertaken. In other words the characteristic data records are compared with each other according to their assignment depending on the coarse or if necessary the fine classification of the characteristic data records.

It can occur however, that for minimally differing characteristics between two characteristic data records of text blocks to be investigated, a new assignment of the characteristics is undertaken, by the differing characteristic being assigned in a gap of the characteristic data record, so that only the same types of characteristics of the two characteristic data records are compared. In other words, for a differing characteristic and further identical characteristics between two characteristic data records between two text blocks, a new assignment of one of the characteristic data records is undertaken, so that a maximum number of characteristics of the same categories can be compared from the two characteristic data records. Such a case can occur for example when a proportion of the text is missing from the text block, preferably because of a missing line in the text block of a postal item compared to a complete text block at another location which should have been similar to the first text block.

The invention will now be explained below in an exemplary embodiment with reference to the drawings. The exemplary embodiment describes the identification of postal items in sorting installations. These postal items generally pass through a number of sorting machines in postal logistics, in which they always have to be identified once again.

The figures show

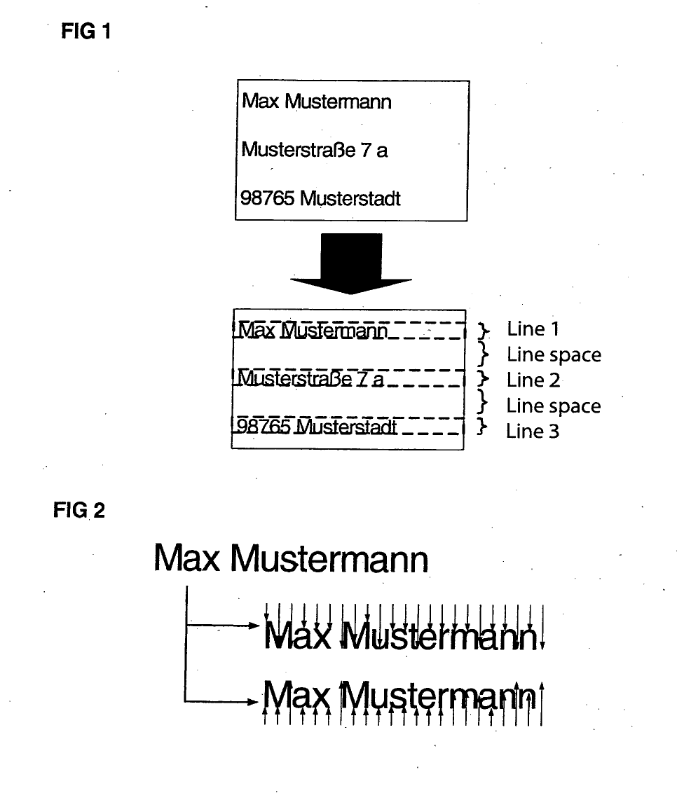

FIG. 1 an address field broken down into lines,

FIG. 2 generation of a line profile,

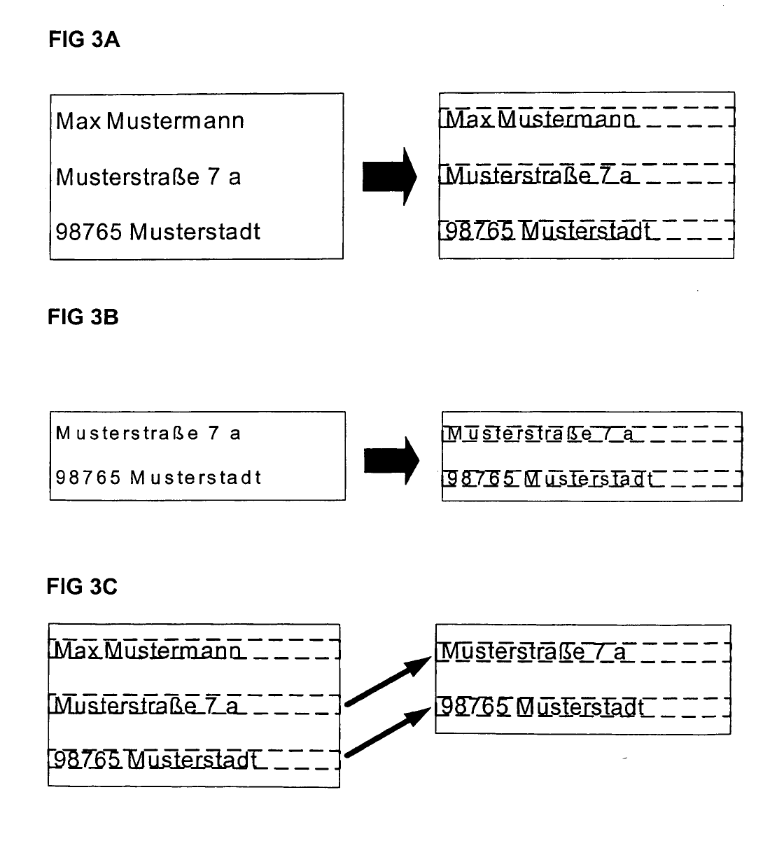

FIG. 3A detection of an address field of a postal item,

FIG. 3B detection of the same address field in a new postal item with a missing line,

FIG. 3C a re-assignment of lines.

To improve the pictorial identification of postal items characteristics and associated identification methods must be introduced by way of support which more closely describe text blocks and especially addresses and investigate the similarities between them. A prerequisite for this is detected text objects within the postal items. These text objects can be divided into two types, with these being
general texts, representing printed promotional texts and such like, or
addresses which specify the recipient or sender of an item.

In general each postal item contains at least one text block, but usually contains more than one. Especially to distinguish address fields, which are very similar in their structure, characteristic values must be defined which describe said structures in great detail.

For description of text blocks characteristics are subdivided into:
characteristics which produce a coarse description of the texts and/or are used for pre-classification, as well as
characteristics which describe the texts in great detail and are used for fine classification.

For performance reasons an initial attempt is made to exclude at an early stage text blocks of which the layout does not correspond to the text block sought. The advantage of this is that complex characteristics connected with complex analysis methods are only employed when this appears necessary. This thus optimizes the quality and timing of the computation of the similarity.

The aim of characteristics used for the first classification is to make a rough distinction between text blocks as regards their similarity. The particular characteristics involved here are as follows:
the size of the text block,
the position of the text block within the postal item,
the number of lines,
size of spaces between lines,
the type height and
how full the text block is.

FIG. 1 shows what is understood in relation to the characteristic data record by a line and a line space when an address field in its full extent (above) is broken down into three lines 1, 2, 3 (below). The type height (e.g. largest letter of the line) then corresponds to a line height. On the basis of these characteristics in combination with simple measures of distance and decision-making methods, a coarse analysis or classification of the similarity between two texts can be undertaken. They can be detected easily, quickly and reliably and require negligible amounts of storage.

Text blocks which have similarities based on these criteria are investigated as to their similarity with more complex methods. To this end the structure of a text on the one hand and the text lines occurring on the other hand are investigated more precisely. With the aid of the detected lines the following characteristics can be identified in a second finer classification:
Number of coherent regions per line,
Color transition matrices which provide information about the structure of a line,
Statistics about frequencies of particular types of coherent regions (in such cases for example a categorization according to size can be undertaken.) as well as
Line profiles.

FIG. 2 outlines a generation of an upper line profile in which a very much more detailed characteristic data record is produced by the use of line profiles. In this case a characteristic data record is determined for each line of which the entries provide information about how far the lettering of a line at a specific position is from the upper or lower edge of the line. A line is thus sampled at discrete distances from the top and the bottom. The associated distances are quantized and stored according to their sequence in a characteristic data record. Such a vector provides a detailed reflection of the structure of a line. On the one hand the characteristic data record is reduced by sampling and quantizing, on the other hand specific image faults can be compensated for in this way.

The first described characteristics, such as the number of coherent regions per line, can be investigated by means of simple measures of distance and distinction methods. Line profiles however require a more complex measure of distance, since the vectors are greatly dependent on the detected text block. Slight displacements lead to changes in the characteristic data record. To determine the distance therefore a measure of distance is needed which takes into account the influence of such displacements.

With the inventive identification or in the retrieval of text blocks variations can arise in different images of the same postal items. An example of this is depicted in FIG. 3A, 3B, 3C with a loss of a line of text. For this reason, in addition to determining the spacing for individual lines of two text blocks, different assignment options for lines in accordance with FIG. 3C must also be considered. This reassignment of the characteristics must be taken into account in the two characteristic data records, so that for example in the characteristic data records the first line “Max Mustermann” from FIG. 3A is not compared with the first line “Musterstrasse 7a” from FIG. 3B.

Subsequently characteristics such as the computed distances between lines from two address fields can be sensibly compared, so that a statement relating to the similarity of the two text blocks can be made.

1.-10. (canceled)

11. A method for classification of text blocks in printed material which is part of bulk postal items, comprising:
extracting structure-related characteristics of one of the text blocks of a postal item, wherein the characteristics are characterized by graphical properties of the overall text block;
assigning the extracted structure-related characteristics to a characteristic data record of the postal item; and
comparing a characteristic data record of a reference text block to the characteristic data record of the postal item.

12. The method of claim 11, wherein, in a first classification of the text block, the structure-related characteristics contain a position of the text block on the postal item.

13. The method of claim 12, wherein in the first classification of the text block, the structure-related characteristics contain at least one of the following characteristics: a size of the text block, an occupancy of the text block, a number of lines in the text block, a size of spaces between lines in the text block and a type height of lines in the text block.

14. The method of claim 11, wherein in a second classification of the text block the structure-related characteristics contain at least one of the following characteristics: a number of coherent regions within individual lines, frequency of coherent regions, color value transitions in a line, matrix form for more than one line and line profiles.

15. The method of claim 14, wherein characteristics of the line profile with spacings of lettering from an upper and lower edge of the line are entered in the characteristic data record of the postal item.

16. The method of claim 11, wherein with one differing characteristic and further identical characteristics between two characteristic data records of two text blocks, a new assignment of one of the characteristic data records is executed, so that a maximum number of characteristics of the same categories is compared from the two characteristic data records.

17. The method of claim 16, wherein a differing characteristic is a missing part of the text in the text block.
